(19) United States
(12) Patent Application Publication
(10) Pub. No.: US 2012/0306623 A1
(43) Pub. Date: Dec. 6, 2012

(54) SYSTEM AND METHOD FOR AUTOMATED MONITORING OF STUDENTS' WORK IN AN EDUCATIONAL ENVIRONMENT

(76) Inventor: Will H. CORBIN, Gaithersburg, MD (US)

(21) Appl. No.: 13/436,691

(22) Filed: Mar. 30, 2012

Related U.S. Application Data
(63) Continuation-in-part of application No. 13/340,922, filed on Dec. 30, 2011.
(60) Provisional application No. 61/428,309, filed on Dec. 30, 2010.

(51) Int. Cl. G06K 7/01

(52) U.S. Cl. 340/10.1

(57) ABSTRACT

A system and method for the automated monitoring of an individual's work is provided that utilizes wireless tags affixed to projects and to the individuals that have access to the projects. The system and method can determine when a particular individual takes a particular project to work on based on the presence of the project and the individual within the sensing area. The presence of the individuals and projects within the sensing area is determined by detecting the presence of the wireless tags with a wireless sensor. The wireless tags are suitably implemented with RFID tags.

This application is a continuation-in-part of U.S. patent application Ser. No. 13/340,922, filed on Dec. 30, 2011, which claims priority to U.S. Provisional Application Ser. No. 61/428,309, filed Dec. 30, 2010. The disclosures of U.S. patent application Ser. No. 13/340,922 and U.S. Provisional Application Ser. No. 61/428,309 are incorporated herein by reference.

### BACKGROUND OF THE INVENTION

1. Field of the Invention

The present invention relates to automated monitoring of a student's work in an educational environment and, more specifically, automated monitoring of what projects students work on over a period of time.

2. Background of the Related Art

The “Montessori” style of education has grown in popularity in the United States. One of the essential elements in a Montessori educational environment is student choice of activity from within a prescribed range of options. Specifically, a number of projects are made available to students and the students are free to choose which project they work and how long they work on it.

Projects are typically stored on open shelves. When students choose to work with a project, they take the project from the shelf, spread it out on a table or on the floor, attempt to perform the required steps for that project, and return the project to the shelf when they are done.

The advantage of having no fixed curriculum or checklist of projects to be worked on is that the student essentially creates their own individual learning plan, suited to their interests and abilities. The disadvantage of this approach is that students may neglect some projects or even entire classes of projects. The Montessori teacher is supposed to monitor each student's progress and activities. However, it can often be difficult for the teacher to keep track of every project being worked on by every student, as well as the time being spent by each student on each project. For example, a teacher may become preoccupied assisting a student that has questions about a project and may not notice that other students may have put their projects back and chosen another project. Thus, the teacher may not be able to accurately monitor the progress and activities of every student.

### SUMMARY OF THE INVENTION

An object of the invention is to solve at least the above problems and/or disadvantages and to provide at least the advantages described hereinafter.

Therefore, an object of the present invention is to provide a system and method for the automated monitoring of an individual's work.

Another object of the present invention is to provide a system and method for the automated monitoring of a student's work in an educational environment.

Another object of the present invention is to provide a system and method for automated tracking and monitoring of which projects a student works on and how long a student works on the projects they choose.

Another object of the present invention is to derive information from the automated tracking and monitoring data that may be of interest to parents, teachers, school administrators, educational researchers and/or others.

To achieve at least the above objects, in whole or in part, there is provided a monitoring system, comprising a wireless sensor adapted to detect the presence of a wireless tag when the wireless tag is within a sensing area, at least one project positioned within the sensing area, wherein each project comprises at least one project component and at least one project wireless tag associated with and affixed to the at least one project component, at least one individual, at least one monitoring wireless tag associated with and positioned on each individual, and a processor in communication with the wireless sensor for receiving signals from the wireless sensor, wherein the processor monitors the presence of the at least one project and the at least one individual within the sensing area based on the presence of respective project wireless tags and monitoring wireless tags within the sensing area.

To achieve at least the above objects, in whole or in part, there is also provided a monitoring method, comprising the steps of associating a project wireless tag with a respective project, associating a monitoring wireless tag with a respective individual, providing a wireless sensor that is adapted to detect the presence of project wireless tags and monitoring wireless tags when the project wireless tags and monitoring wireless tags are located within a sensing area, and recording the times at which projects and individuals enter and exit the sensing area based on the detection of the project wireless tags and monitoring wireless tags within the sensing area by the wireless sensor.

### BRIEF DESCRIPTION OF THE DRAWINGS

The invention will be described in detail with reference to the following drawings in which like reference numerals refer to like elements wherein:

FIG. 1 is a block diagram showing the components of one preferred embodiment of the system of the present invention, and illustrating all projects within the sensing area and all individuals within the work area;

FIG. 2 is a block diagram of the system of FIG. 1 and illustrating one of the individuals within the sensing area;

FIG. 3 is a block diagram of the system of FIG. 1 and illustrating one of the individuals and one of the projects exiting the sensing area and entering the work area;

FIG. 4 is a block diagram of the system of FIG. 1 and illustrating the individual and project reentering the sensing area; and

FIG. 5 is a block diagram of the system of FIG. 1 and illustrating all of the projects back in the sensing area and all of the individuals back in the work area.

### DETAILED DESCRIPTION OF PREFERRED EMBODIMENTS

The present invention is particularly suited for the automated monitoring of a student's interaction with an educational project, such as in a Montessori educational environment. However, it should be appreciated that the present invention can be applied to any environment in which a person's interaction with a project or object needs to be monitored, and the present invention will be described and illustrated in such general terms.

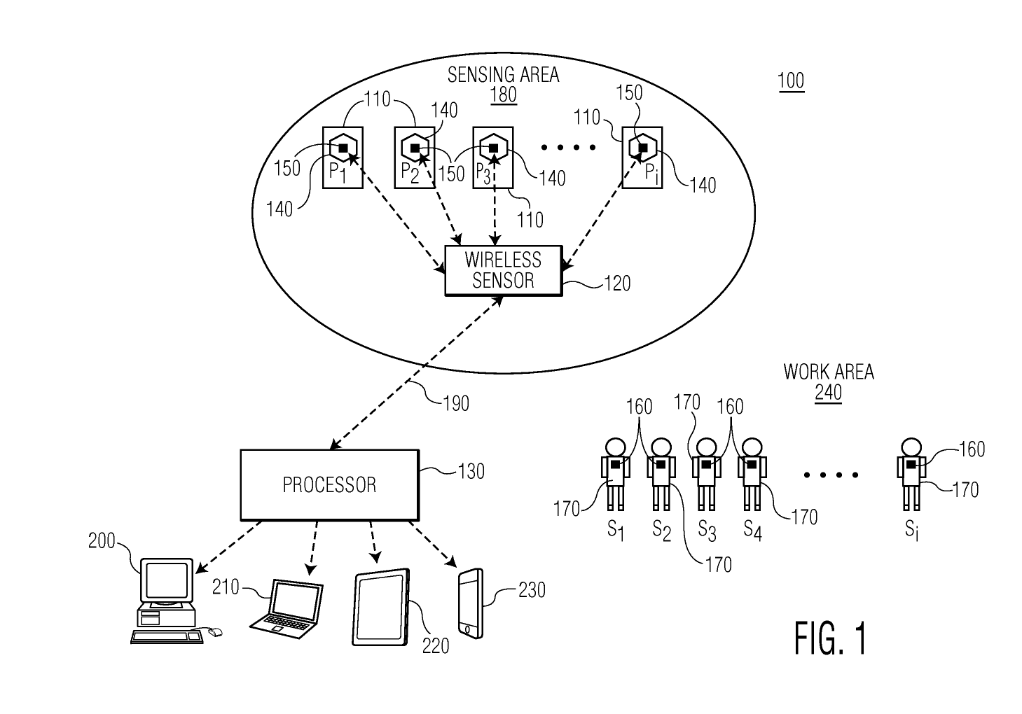

FIG. 1 is a block diagram showing the basic components of a preferred embodiment of the monitoring system of the present invention. The monitoring system 100 includes multiple projects 110 (individually labeled as P₁, P₂, P₃ . . . Pᵢ) that include at least one project component 140, a wireless sensor 120, a processor 130, project wireless tags 150 and monitoring wireless tags 160.

At least one project wireless tag 150 is affixed to at least one of the project components 140 associated with each project 110. Project components 140 may include papers, tools or any other material with which an individual will be working to complete the project 110. A project component 140 may also be a portable container in which other project components 140 associated with a project 110 are stored. Each project wireless tag 150 is configured to uniquely identify the project 110 with which it is associated. The project wireless tags 150 may be affixed to respective project components using any means known in the art such as, for example, removable adhesive, clips, etc.

Although FIG. 1 shows one project wireless tag 150 affixed to one of the project components 140 associated with each project 110, multiple project wireless tags 150 may be affixed to one or more of the project components 140 in order to provide redundancy, should one of the project wireless tags fail, and/or to improve signal detection performance. Illustrative examples of project wireless tag configurations include, but are not limited to: (1) a separate respective project wireless tag 150 is affixed to every project component 140 that is associated with a project 110; (2) a separate respective project tag 150 is affixed to at least two respective project components 140 that are associated with a project 110; (3) at least two project wireless tags 140 are respectively affixed to at least two of the project components 140 that are associated with a project 110; and (4) at least two project wireless tags are affixed to one of the project components 140 that is associated with a project 110.

Respective monitoring wireless tags 160 are positioned in close proximity to respective individuals 170 (individually labeled as S₁, S₂, S₃ . . . Sᵢ). Each monitoring wireless tag 160 is configured to uniquely identify the individual 170 with which it is associated. The monitoring wireless tags 160 may be positioned in close proximity to respective individuals 170 using any means known in the art such as, for example, affixing the monitoring wireless tag 160 to the clothing of the individual 170 using removable means (e.g., a clip, removable adhesive, etc.) or by affixing the monitoring wireless tags 160 to a lanyard (not shown) that can be worn around the necks of individuals 170.

Although FIG. 1 shows one monitoring wireless tag 160 associated with each individual 170, multiple monitoring wireless tags 160 may associated with each individual 170, in order to provide redundancy, should one of the monitoring wireless tags fail, and/or to improve signal detection performance.

The wireless sensor 120 is adapted to wirelessly detect the presence of either project wireless tags 150 or monitoring wireless tags 160 when they enter a predetermined sensing area 180. The wireless sensor 120 sends information related to the presence of project wireless tags 150 and monitoring wireless tags 160 within the sensing area 180 to the processor 130 via communications link 190.

The project wireless tags 150 and the monitoring wireless tags 160 are preferably radio frequency identification (RFID) tags, and the wireless sensor 120 is preferably an RFID reader. Any type of RFID tags and readers known in the art may be used to implement the project wireless tags 150 and the monitoring wireless tags 160, as long as the RFID tags may be affixed to the project components 140 and the individuals 170, as described above.

The RFID tags used to implement the project wireless tags 150 and the monitoring wireless tags 160 may be passive tags, which do not have a power source, or active tags, which do have a power source and that broadcasts or beacons its signal. The RFID tags typically contain an integrated circuit (IC) that includes memory, which may be read-write or read-only memory. For example, the IC in each RFID tag may be programmed by the manufacturer with certain fixed information that is not intended to be altered, such as a serial number or other unique identification number. The IC in each RFID tag may also be programmable by a user, such that a user may program the RFID tag with customized information.

If the RFID tags used for the project wireless tags 150 and the monitoring wireless tags 160 are not programmable and only contain a fixed and unique identification number in read-only memory that is readable by the RFID reader used for the wireless sensor 120, then each project 110 and individual 170 that is located within the sensing area 180 is uniquely identified by the wireless sensor 120 and processor 130 by associating each project 110 and individual 170 with the identification number of its respective wireless tag.

If the RFID tags used for the project wireless tags 150 and the monitoring wireless tags 160 have programmable memory that is readable by the RFID reader used for the wireless sensor 120, then additional customized information related to a project 110 or individual 170 may be programmed into its respective RFID tag. In this case, projects 110 and individuals 170 that are located within the sensing area 180 can be uniquely identified by the wireless sensor 120 and processor 130 by associating each project 110 and individual 170 with the identification number of its respective wireless tag, or by reading the additional customized information that was programmed into the respective RFID tag.

As discussed above, the RFID tags and reader used to implement the project wireless tags 150, the monitoring wireless tags 160 and the wireless sensor 120 can be either passive or active. Active RFID tags utilize internal batteries to broadcast a signal to the RFID reader. Because the RFID signal is broadcast utilizing the RFID tag's own power souce, the RFID reader can pick up the RFID signal from the RFID tag from 100 feet or more away.

In contrast, passive RFID tags do not utilize an internal power source and instead rely entirely on the RFID reader as their power source. Specifically, the RFID reader broadcasts an electromagnetic signal that is received by the passive RFID tag. The passive RFID tag harvests power from the RFID reader's electromagnetic signal and sends a radio signal back to the RFID reader. Most typical passive RFID tags must be no greater than approximately 20 feet away from the RFID reader in order for the RFID reader to detect the radio signal from the passive RFID tag.

The project wireless tags 150 and the monitoring wireless tags 160 are preferably implemented with passive RFID tags, which are much less costly than active RFID tags. The sensing area 180 is preferably defined by the detection range of the passive RFID tags used to implement the wireless tags 150 and 160. Specifically, when the wireless sensor 120 is positioned at a fixed location, the sensing area 180 is defined as the area over which the passive RFID tags that are used to implement wireless tags 150 and 160 can be read by the wireless sensor 120. If active RFID tags are used, then the sensing area 180 would be larger due to the fact that active RFID tags can be read over longer distances than passive RFID tags. The area outside the sensing area 180 is designated as the work area 240. The system 100 assumes that when a project is outside the sensing area 180, it is being worked on in the work area 240.

The sensing area 180, work area 240 and other components of the present invention are schematically shown in FIGS. 1A-1E for purposes of illustration, and therefore the relative size and shape of the sensing area 180 and work area 240, the relative sizes of the other components, and the distances between components are not to scale and no inferences should be made with regards to distances, shapes and sizes based on FIGS. 1A-1E. For example, the sensing area 180 is shown as oval shape for illustrative purposes, but the actual shape and size of the sensing area 180 is dependent on detection ranges of the RFID tags used to implement the wireless tags 150 and 160.

The processor 130 receives signals from the wireless sensor 120 over communications link 190 that contain information related to the presence of wireless tags 150 and 160 within the sensing area 180. The information includes at least identification information for any wireless tag that enters the sensing area 180. The processor 120 is programmed to associate each wireless tag's unique identification information with the project or individual with which it is associated. The information received by the processor 120 may also include additional information related to the project or individual with which a wireless tag is associated, if the wireless tag 150/160 is a programmable RFID tag and such additional information has been programmed into the RFID tag.

The processor 120 may be implemented with a general purpose desktop computer 200 or a general purpose laptop computer 210. In addition, the processor 120 may be implemented with a tablet computer 220 or smartphone 230, such as iOS or Android based tablets and smartphones. However, processor 130 can also be implemented with a special purpose computer, programmed microprocessor or microcontroller and peripheral integrated circuit elements, ASICs or other integrated circuits, hardwired electronic or logic circuits such as discrete element circuits, programmable logic devices such as FPGA, PLD, PLA or PAL or the like. In general, any device on which a finite state machine capable of executing code for implementing the functionality described herein can be used to implement the processor 130.

Communications link 190 between wireless sensor 120 and processor 130 can be either a hardwired link or a wireless link, but is preferably a wireless link using any components and techniques known in the art for establishing a communications link between a wireless sensor 120 (such as an RFID reader) and a processor 130. Communications link 190 may be, include or interface to any one or more of for instance, the Internet, an intranet, a PAN (Personal Area Network), a LAN (Local Area Network), a WAN (Wide Area Network) or a MAN (Metropolitan Area Network), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34bis analog modem connection, a cable modem, an ATM (Asynchronous Transfer Mode) connection, an FDDI (Fiber Distributed Data Interface) or CDDI (Copper Distributed Data Interface) connection. Communications link 190 may furthermore be, include or interface to any one or more of a WAP (Wireless Application Protocol) link, a GPRS (General Packet Radio Service) link, a GSM (Global System for Mobile Communication) link, CDMA (Code Division Multiple Access) or TDMA (Time Division Multiple Access) link, such as a cellular phone channel, a GPS (Global Positioning System) link, CDPD (Cellular Digital Packet Data), a RIM (Research in Motion, Limited) duplex paging type device, a Bluetooth radio link, or an IEEE 802.11-based radio frequency link (WiFi). Communications link 190 may yet further be, include or interface to any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection.

FIGS. 1-5 also illustrate an example of how the system 100 operates to monitor what projects an individual works on. The projects 110 are stored within the sensing area 180, such as on one or more shelves located in the sensing area 180. In FIG. 1, all the projects 180 are located within the sensing area 180 and all individuals 170 are located in the work area 240.

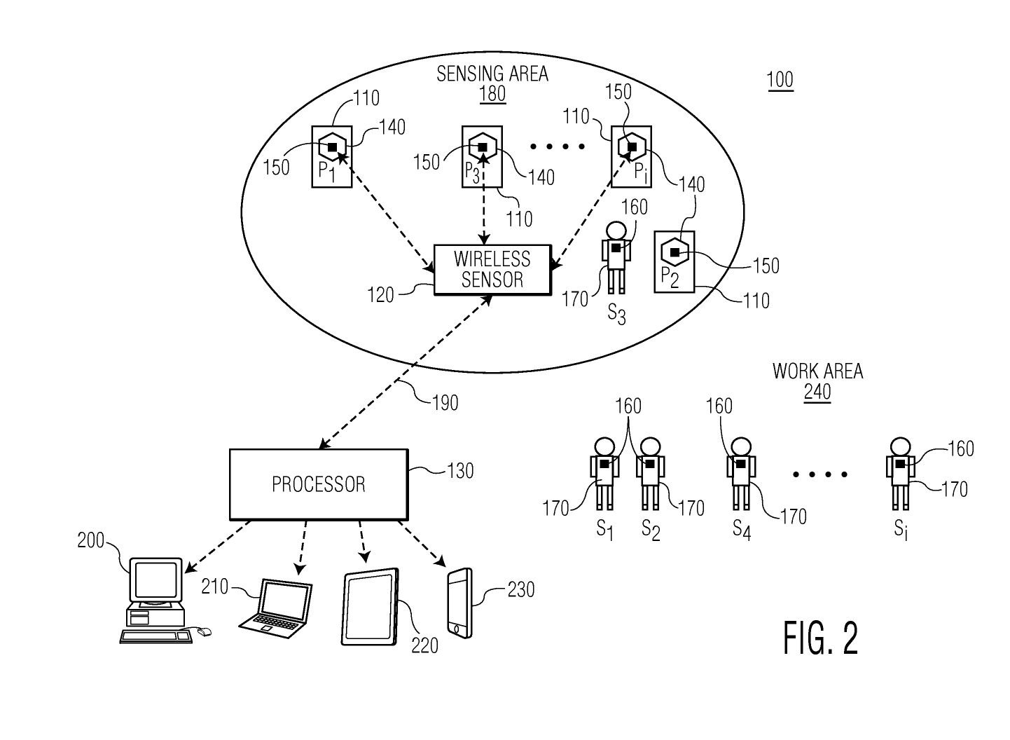

In FIG. 2, individual S₃ has entered the sensing area 180 and has picked up project P₂. Because individual S₃ is now within the sensing area, the wireless sensor 120 picks up the presence of individual S₃ via the monitoring wireless tag 160 assigned to individual S₃, and relays that information to the processor 130. The wireless sensor 120 is also picking up the presence of all the projects 110 within the sensing area 180 via their respective project wireless tags 150.

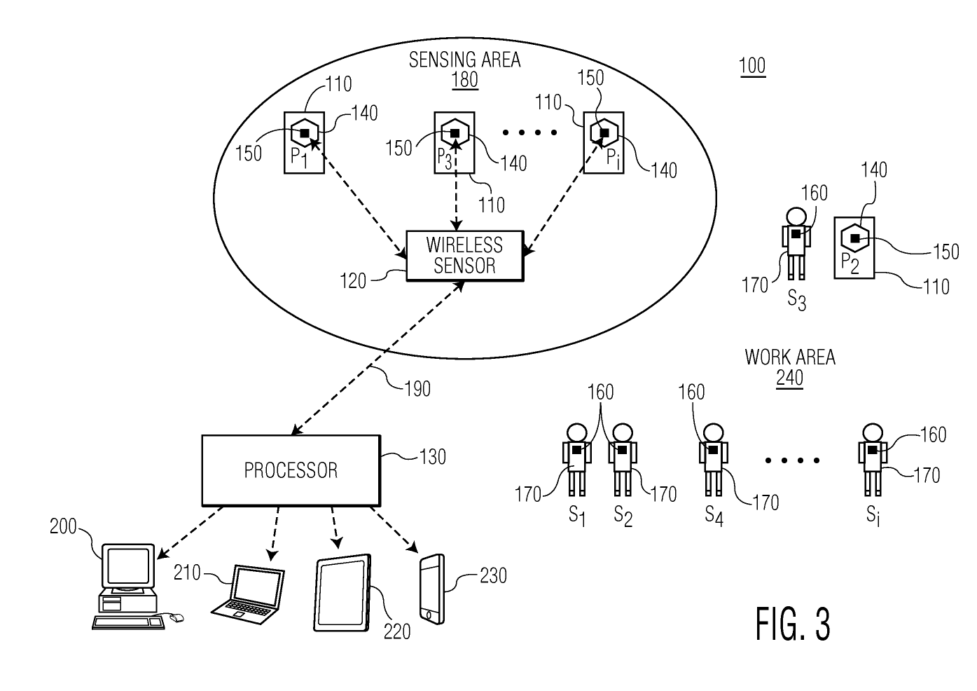

In FIG. 3, individual S₃ and project P₂ have left the sensing area 180 and have entered the work area 240. The wireless sensor 120 can no longer detect the presence of either individual S₃ or project P₂, and processor 130 records the time at which individual S₃ and project P₂ left the sensing area 180.

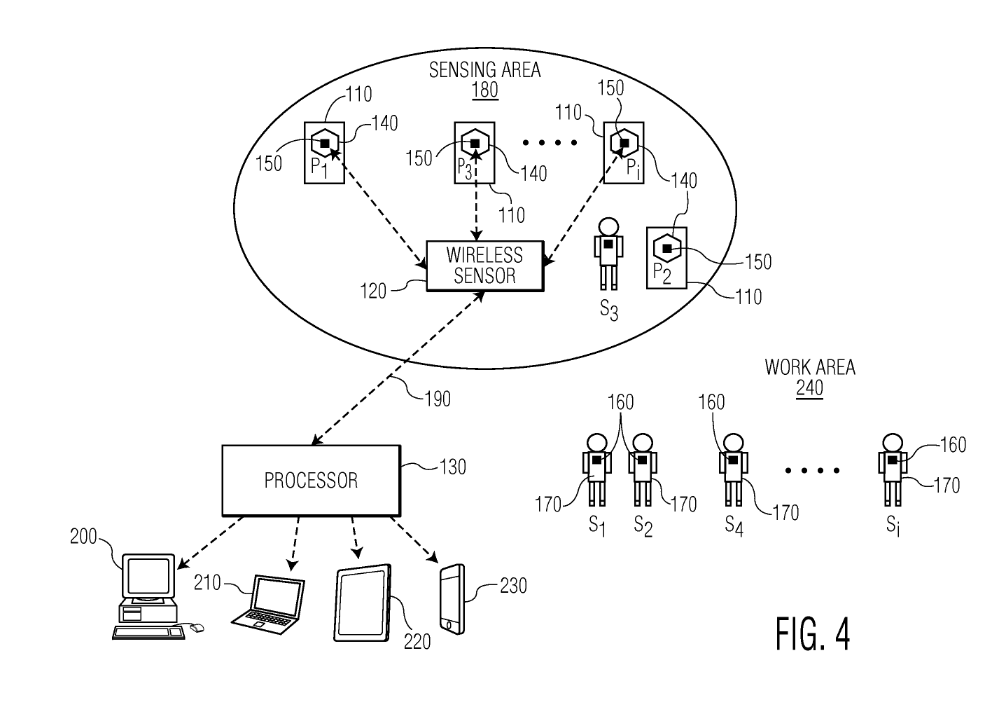

In FIG. 4, individual S₃ has taken project P₂ back into the sensing area 180 in order to put project P₂ back in its storage area, presumably after having worked on the project for some period of time. The wireless sensor 120 detects the presence of both individual S₃ and project P₂, and processor 130 records this event.

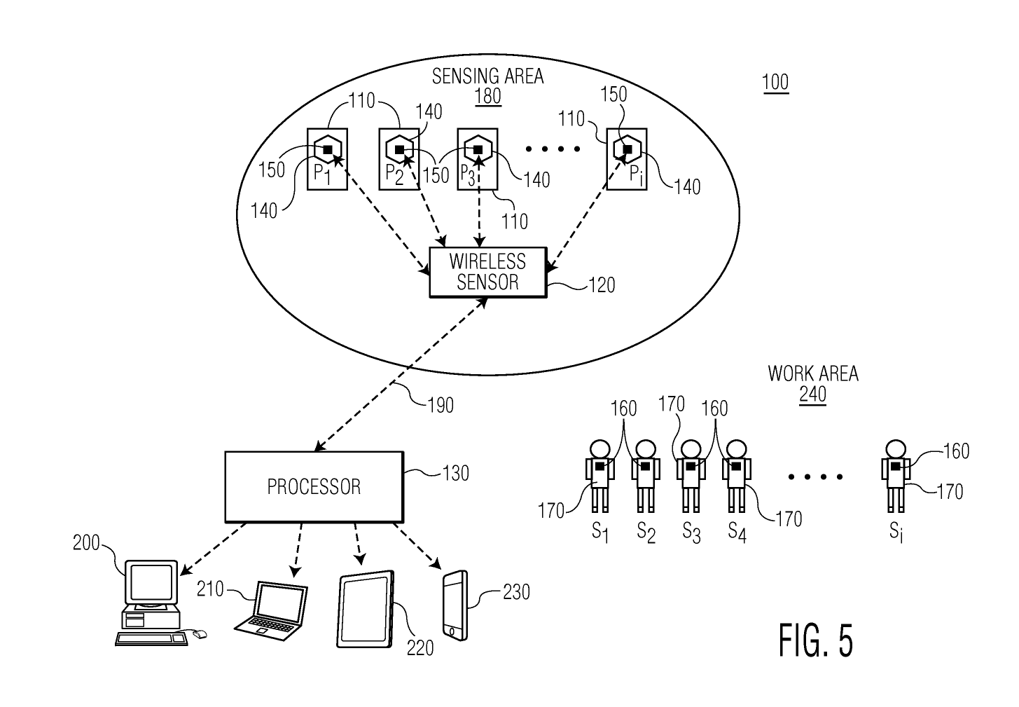

In FIG. 5, individual S₃ has left the sensing area without taking another project 110. Thus, the wireless sensor 120 detects the presence of all the projects 110 within the sensing area 180 and does not detect any individuals 170 within the sensing area 180.

A user of system 100 can make useful inferences based on the presence or non-presence of individuals 170 and projects 110 within the sensing area 180, as well as the contemporaneous departures from and arrivals to the sensing area 180 of individuals 170 and projects 110, as will now be explained.

A contemporaneous departure from the sensing area 180 of a project 110 and individual 170 can be interpreted as that individual 170 having taken a project 110 out of the sensing area 180 in order to work on that project. A contemporaneous entry of a project 110 and individual 170 into the sensing area 180 can be interpreted as that individual 170 returning the project 110 back to its storage area after having worked on the project. The processor 130 can thus keep track of the projects 170 being worked on by each individual 170, as well as the amount of time each individual 170 has the project 110 before returning the project 110 to its storage area.

In an educational environment, the individuals 170 are students and the processor 130 can log which student 170 works with which project 110, when the student 170 works with a particular project 110, and the duration of that effort. Performance trends can be interesting and informative to teachers, administrators, and/or parents. For example, if a particular student 170 has never tried to work on half of the projects available to them, the teacher may want to direct the student 170 toward the neglected projects. As another example, if none of the students 170 has ever worked with a subset of the projects, the teacher may want to verify that the project is in working order and that the project has been adequately demonstrated to the class.

A major benefit of the system 100 is that accurate records can be kept, and significant trends identified, without distracting the instructor from their already busy and demanding schedule. In a preferred embodiment, the processor 130 is programmed for generating reports that may be of interest to parents, teachers, school administrators, educational researchers and/or others based on the information obtained by the system 100 as to the time and duration of student/project pairings. These reports can include, but are not limited to, the following: (1) a list of project work times and durations for a particular student; (2) a list of project work times and durations for a classroom; (3) a list of projects used most frequently; (4) a list of projects used least frequently or not at all; (5) the order in which a particular student worked on projects; (6) the time of day particular projects are selected; (7) the time of day particular students are busy with projects; (8) the time of day groups of students are busy with projects; and (9) a list the most busy and least busy students in terms of total project time and number of projects used.

Although the above-described event logging and report generation by the processor 130 has been described in the context of an educational environment, the time and duration of individual/project pairings can be used in other work environments and reports relevant to that work environment can be generated by the processor 130 while still falling within the scope of the present invention.

The foregoing embodiments and advantages are merely exemplary, and are not to be construed as limiting the present invention. As indicated above, the present teachings can be readily applied to other environments. The description of the present invention is intended to be illustrative, and not to limit the scope of the claims. Many alternatives, modifications, and variations will be apparent to those skilled in the art. Various changes may be made without departing from the spirit and scope of the present invention, as defined in the following claims.

What is claimed is:

1. A monitoring system, comprising:
a wireless sensor adapted to detect the presence of a wireless tag when the wireless tag is within a sensing area;
at least one project positioned within the sensing area, wherein each project comprises,
at least one project component, and
at least one project wireless tag associated with and affixed to the at least one project component;
at least one individual;
at least one monitoring wireless tag associated with and positioned on each individual; and
a processor in communication with the wireless sensor for receiving signals from the wireless sensor, wherein the processor monitors the presence of the at least one project and the at least one individual within the sensing area based on the presence of respective project wireless tags and monitoring wireless tags within the sensing area.

2. The system of claim 1, wherein the wireless sensor comprises a radio frequency identification (RFID) reader, and the project and subject wireless tags comprise RFID tags.

3. The system of claim 1 wherein the processor determines that an individual has taken a project out of the sensing area when the individual's respective monitoring wireless tag and the project's respective project wireless tag leave the sensing area at substantially the same time.

4. The system of claim 3, wherein the processor determines that the individual has returned the project to the sensing area when the project's respective project wireless tag re-enters the sensing area.

5. The system of claim 1, wherein the sensing area is defined by a range over which the monitoring wireless tags can be detected by the wireless sensor.

6. The system of claim 3, wherein the RFID tags comprise passive RFID tags.

7. The system of claim 6, wherein each RFID tag has a unique identification number that is associated with its respective project or individual.

8. The system of claim 1, wherein the processor is in communication with the wireless sensor via a wireless link.

9. The system of claim 1, wherein the processor comprises a desktop computer, a laptop computer, a tablet computer or a smartphone.

10. The system of claim 1, wherein the processor is programmed to log the times at which projects and individuals enter and exit the sensing area based on the presence of the project wireless tags and monitoring wireless tags within the sensing area.

11. The system of claim 10, wherein the processor is programmed to determine that an individual is working on a project when the individual and the project exit the sensing area at substantially the same time.

12. The system of claim 11, wherein the processor is programmed to determine that the individual is no longer working on the project when the project reenters the sensing area.

13. The system of claim 10, wherein the processor is programmed to generate reports based on the times at which projects and individuals enter and exit the sensing area.

14. A monitoring method, comprising the steps of:
associating a project wireless tag with a respective project;
associating a monitoring wireless tag with a respective individual;
providing a wireless sensor that is adapted to detect the presence of project wireless tags and monitoring wireless tags when the project wireless tags and monitoring wireless tags are located within a sensing area;
recording the times at which projects and individuals enter and exit the sensing area based on the detection of the project wireless tags and monitoring wireless tags within the sensing area by the wireless sensor.

15. The method of claim 14, further comprising the step of determining that an individual is working on a project when the individual and the project exit the sensing area at substantially the same time.

16. The method of claim 15, further comprising the step of determining that the individual is no longer working on the project when the project reenters the sensing area.

17. The method of claim 14, further comprising the step of generating reports based on the times at which projects and individuals enter and exit the sensing area.

18. The method of claim 14, wherein the project wireless tag and monitoring wireless tag are RFID tags and the wireless sensor is an RFID reader.

19. The method of claim 18, wherein the RFID tags are passive RFID tags.

20. The method of claim 19, wherein the sensing area is defined by a range over which the monitoring wireless tags can be detected by the wireless sensor.
